(19) United States
(12) Patent Application Publication
(10) Pub. No.: US 2008/0304566 A1
(43) Pub. Date: Dec. 11, 2008

(54) Method for Decoding Video Signal Encoded Through Inter-Layer Prediction

(75) Inventors: Doe Hyun Yoon, Seoul (KR); Ji Ho Park, Seoul (KR); Seung Wook Park, Seoul (KR); Byeong Moon Jeon, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/914,948

(22) PCT Filed: May 25, 2006
(86) PCT No.: PCT/KR2006/001979

§ 371 Date: May 22, 2008

Related U.S. Application Data
(60) Provisional application No. 60/684,590, filed on May 26, 2005.
(60) Provisional application No. 60/701,044, filed on Jul. 21, 2005.
(60) Provisional application No. 60/706,443, filed on Aug. 9, 2005.

(30) Foreign Application Priority Data
Sep. 2, 2005 (KR) 10-2005-0081909

(51) Int. Cl. H04N 7/32

(52) U.S. Cl. 375/240.12; 375/E07.243

(57) ABSTRACT

A method for decoding a video signal encoded through inter-layer prediction is provided. When encoded bitstreams of first and second layers are received and decoded into a video signal, pictures of the first layer are predicted from pictures of the second layer. It is determined whether or not inter-layer prediction is constrained under the condition that a target block in the first layer has been coded in an intra mode through prediction from a picture of the second layer. An operation for checking a flag “intra_base_flag” indicating whether or not image data of the target block has been coded into difference data with reference to residual data, coded in an intra mode, of a corresponding block of a different layer is skipped if it is determined that inter-layer prediction is constrained. This eliminates the need for an encoder to transmit the flag under the same condition.

### TECHNICAL FIELD

The present invention relates to a method for decoding a video signal encoded through inter-layer prediction.

### BACKGROUND ART

Scalable Video Codec (SVC) encodes video into a sequence of pictures with the highest image quality while ensuring that part of the encoded picture sequence (specifically, a partial sequence of frames intermittently selected from the total sequence of frames) can be decoded and used to represent the video with a low image quality. Motion Compensated Temporal Filtering (MCTF) is an encoding scheme that has been suggested for use in the scalable video codec.

Although it is possible to represent low image-quality video by receiving and processing part of a sequence of pictures encoded according to a scalable scheme, there is still a problem in that the image quality is significantly reduced if the bitrate is lowered. One solution to this problem is to provide an auxiliary picture sequence for low bitrates, for example, a sequence of pictures that have a small screen size and/or a low frame rate.

The auxiliary picture sequence is referred to as a base layer, and the main frame sequence is referred to as an enhanced or enhancement layer. Video signals of the base and enhanced layers have redundancy since the same video signal source is encoded into two layers. As illustrated in FIG. 1, to increase the coding efficiency of the enhanced layer, one method codes information of a motion vector of a current macroblock in an enhanced layer picture using information of a motion vector of a block in a base layer picture corresponding to the current macroblock if the motion vector of the corresponding block can be used for encoding the current macroblock (S10 and S11). If the motion vector of the corresponding block cannot be used for encoding the current macroblock, a suitable macroblock type for the current macroblock is determined to code the current macroblock according to a conventional method (S12). Here, if the type of the current macroblock is determined to be intra-mode, a flag “intra_base_flag”, which indicates whether or not the current macroblock has been coded into difference data from image data of an intra-mode block in the base layer corresponding to the current macroblock, is transmitted (S13).

The flag “intra_base_flag” is necessary under the condition that it can have a selective value. Specifically, under the condition that the flag “intra_base_flag” can have a selective value of 0 or 1, the decoder requires the flag in order to determine how to reconstruct an image of a current macroblock which has been coded in an intra mode. This indicates that transmission of the flag “intra_base_flag” when the flag must be fixed to either 0 or 1 causes a reduction in the coding gain.

### DISCLOSURE OF INVENTION

Therefore, the present invention has been made in view of the above problems, and it is an object of the present invention to provide a method for decoding a video signal, which determines specific conditions in which information indicating whether or not inter-layer intra-mode prediction has been performed is unnecessary, thereby eliminating the need for an encoder to transmit the information in the specific conditions.

In accordance with one aspect of the present invention, the above and other objects can be accomplished by the provision of a decoding method, wherein, when an encoded bitstream of a first layer and an encoded bitstream of a second layer are received and decoded into a video signal, pictures of the first layer are predicted from pictures of the second layer, it is determined whether or not inter-layer prediction is constrained under the condition that a target block in the first layer has been coded in an intra mode through prediction from a picture of the second layer, and an operation for checking a flag “intra_base_flag” indicating whether or not image data of the target block has been coded into difference data with reference to before-coding data of residual data, coded in an intra mode, of a corresponding block of a different layer is skipped if it is determined that inter-layer prediction is constrained.

In accordance with another aspect of the present invention, there is provided a decoding method, wherein, when an encoded bitstream of a first layer and an encoded bitstream of a second layer are received and decoded into a video signal, pictures of the first layer are predicted from pictures of the second layer, it is determined whether or not inter-layer prediction is constrained and it is also determined whether or not a block of the second layer corresponding to the target block is in an intra mode under the condition that a target block in the first layer has been coded in an intra mode through prediction from a picture of the second layer, and an operation for checking a flag “intra_base_flag” is skipped if it is determined that inter-layer prediction is constrained and the corresponding block of the second layer is not in an intra mode.

In accordance with still another aspect of the present invention, there is provided a decoding method, wherein, when an encoded bitstream of a first layer and an encoded bitstream of a second layer are received and decoded into a video signal, pictures of the first layer are predicted from pictures of the second layer, it is determined whether or not inter-layer prediction is constrained and it is also determined whether or not a block of the second layer corresponding to the target block is in an intra mode under the condition that a target block in the first layer has been coded in an intra mode through prediction from a picture of the second layer, and an operation for checking a flag “intra_base_flag” is skipped if it is determined that the corresponding block of the second layer is in an intra mode or if it is determined that inter-layer prediction is constrained.

In accordance with yet another aspect of the present invention, there is provided a decoding method, wherein, when an encoded bitstream of a first layer and an encoded bitstream of a second layer are received and decoded into a video signal, pictures of the first layer are predicted from pictures of the second layer, it is determined whether or not a block of the second layer corresponding to the target block is in an intra mode under the condition that a target block in the first layer has been coded in an intra mode through prediction from a picture of the second layer, and an operation for checking a flag “intra_base_flag” is skipped if it is determined that the corresponding block of the second layer is not in an intra mode.

In an embodiment of the present invention, it is determined that inter-layer prediction is unconstrained if the picture of the first layer is a key picture and it is indicated that a residual of the block of the second layer corresponding to the target block is to be reconstructed using reconstructed pixel values of an adjacent inter-mode block rather than using a fixed value for the adjacent inter-mode block (i.e., constrained_intra_pred_flag=0).

In another embodiment of the present invention, when the picture of the first layer is a key picture, it is determined that inter-layer prediction is unconstrained if it is indicated that a residual of the block of the second layer corresponding to the target block is to be reconstructed using reconstructed pixel values of an adjacent inter-mode block rather than using a fixed value for the adjacent inter-mode block (i.e., constrained_intra_pred_flag=0), whereas, when the picture of the first layer is not a key picture, it is determined that inter-layer prediction is unconstrained if it is indicated that the picture of the second layer is always to be decoded (always_decode_base_layer=1).

In another embodiment of the present invention, when it is indicated that the picture of the second layer is always to be decoded (always_decode_base_layer=1), it is determined that inter-layer prediction is unconstrained, whereas, when it is indicated that the picture of the second layer is not to be decoded always (always_decode_base_layer=0), it is determined that inter-layer prediction is unconstrained if the picture of the first layer is a key picture and it is indicated that a residual of the block of the second layer corresponding to the target block is to be reconstructed using reconstructed pixel values of an adjacent inter-mode block rather than using a fixed value for the adjacent inter-mode block (i.e., constrained_intra_pred_flag=0).

### BRIEF DESCRIPTION OF DRAWINGS

The above and other objects, features and other advantages of the present invention will be more clearly understood from the following detailed description taken in conjunction with the accompanying drawings, in which:

FIG. 1 illustrates part of a process for encoding a macroblock in a video signal through inter-layer prediction;

FIG. 2 is a block diagram of a decoding apparatus for performing a decoding method according to the present invention;

FIG. 3a illustrates how an intra-BL mode macroblock is predicted from an intra-mode block in a lower layer when inter-layer prediction is constrained;

FIG. 3b illustrates how an intra-BL mode macroblock is predicted from an intra or inter-mode block in a lower layer when inter-layer prediction is unconstrained;

FIGS. 4a-4c illustrate examples of a syntax of an operation for checking a flag “intra_base_flag” in a decoding procedure in which it is determined whether or not inter-layer prediction is constrained according to an embodiment of the present invention; and

FIGS. 5-7 illustrate examples of a syntax of the operation for checking a flag “intra_base_flag” in a decoding procedure according to another embodiment of the present invention.

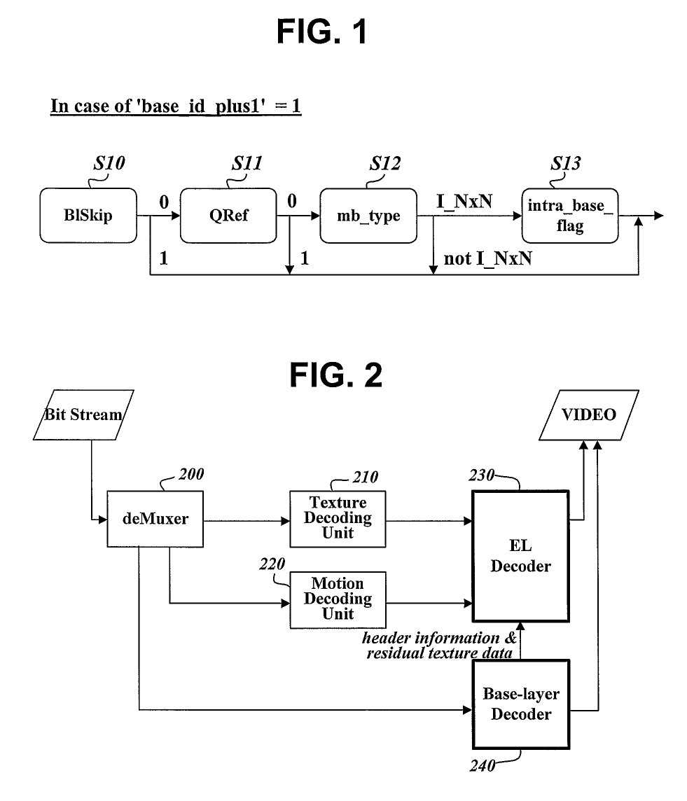

### MODES FOR CARRYING OUT THE INVENTION

Preferred embodiments of the present invention will now be described in detail with reference to the accompanying drawings.

FIG. 2 is a block diagram of an apparatus for decoding an encoded data stream. The decoding apparatus of FIG. 2 includes a demuxer (or demultiplexer) 200, a texture decoding unit 210, a motion decoding unit 220, an enhanced layer (EL) decoder 230, and a base layer (BL) decoder 240. The demuxer 200 separates a received data stream into a compressed motion vector stream, a compressed macroblock information stream, and a base layer stream. The texture decoding unit 210 reconstructs the compressed macroblock information stream to its original uncompressed state. The motion decoding unit 220 reconstructs the compressed motion vector stream to its original uncompressed state. The EL decoder 230 converts the uncompressed macroblock information stream and the uncompressed motion vector stream back to an original video signal, for example, according to an MCTF scheme. The BL decoder 240 decodes the base layer stream according to a specified scheme, for example, according to the MPEG-4 or H.264 standard. The BL decoder 240 not only decodes an input base layer stream but also provides a header in the stream to the EL decoder 230 to allow the EL decoder 230 to use necessary encoding information of the base layer included in the header, for example, motion vector-related information and macroblock mode information.

When receiving coding information of the lower layer from the base layer decoder 240, the EL decoder 230 determines whether or not it is necessary to check a flag “intra_base_flag” of a current macroblock of the enhanced layer, which will be described below in detail. In the following description of the embodiments, the term ‘picture’ is used to indicate a frame or a slice, provided that the use of the term is technically feasible. Here, slices are obtained by dividing a frame.

The EL decoder 230 does not check a flag “intra_base_flag” for the current macroblock in the case of constrained inter-layer prediction (also referred to as “single-loop prediction”).

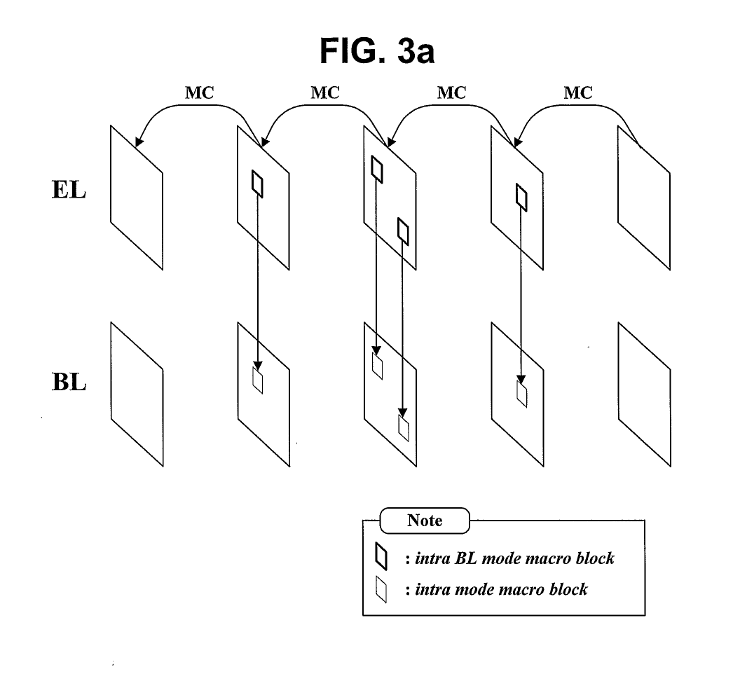

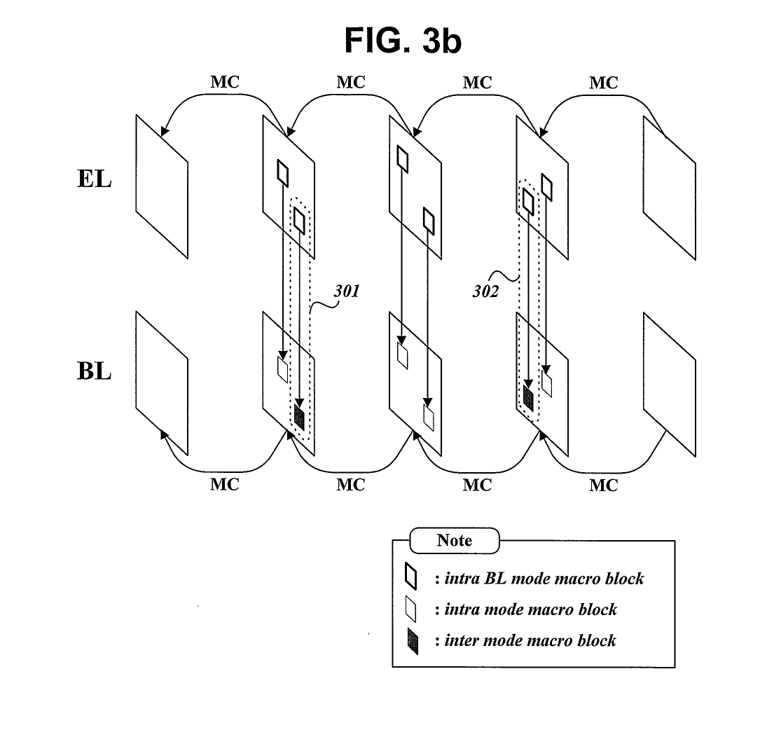

As illustrated in FIG. 3a, if there is a constraint on inter-layer prediction when a current macroblock in the enhanced layer is an intra-BL mode block, inter-layer prediction (i.e., the operation for coding into residual data with reference to an image reconstructed from a corresponding block in the base layer) is allowed for the current macroblock in the enhanced layer when the macroblock in the base layer corresponding to the current macroblock has been coded in an intra mode, whereas inter-layer prediction is not allowed for the current macroblock when the corresponding macroblock in the base layer has been coded in an inter mode. Here, whether or not inter-layer prediction is allowed can also be determined by a BlSkip flag. If the BlSkip flag is 0 when the current macroblock is an intra-BL mode block, this indicates that the corresponding block in the base layer is in an inter mode, so that there is no need to check the flag “intra_base_flag” indicating whether or not the current macroblock has been predicted from the corresponding block. Accordingly, the encoder does not need to transmit the flag “intra_base_flag” under the same condition.

FIG. 3b shows an example of unconstrained inter-layer prediction (also referred to as “multi-loop prediction”) contrary to the constrained inter-layer prediction of FIG. 3a. In this example, inter-layer prediction (301 and 302) is allowed for a current macroblock in the enhanced layer, which is an intra-BL mode block, even when a corresponding block in the base layer has been coded in an inter mode. Accordingly, in this case, the EL decoder 230 checks a flag “intra_base_flag” for the current macroblock in order to determine whether or not the current macroblock has been predicted from the corresponding block in the base layer.

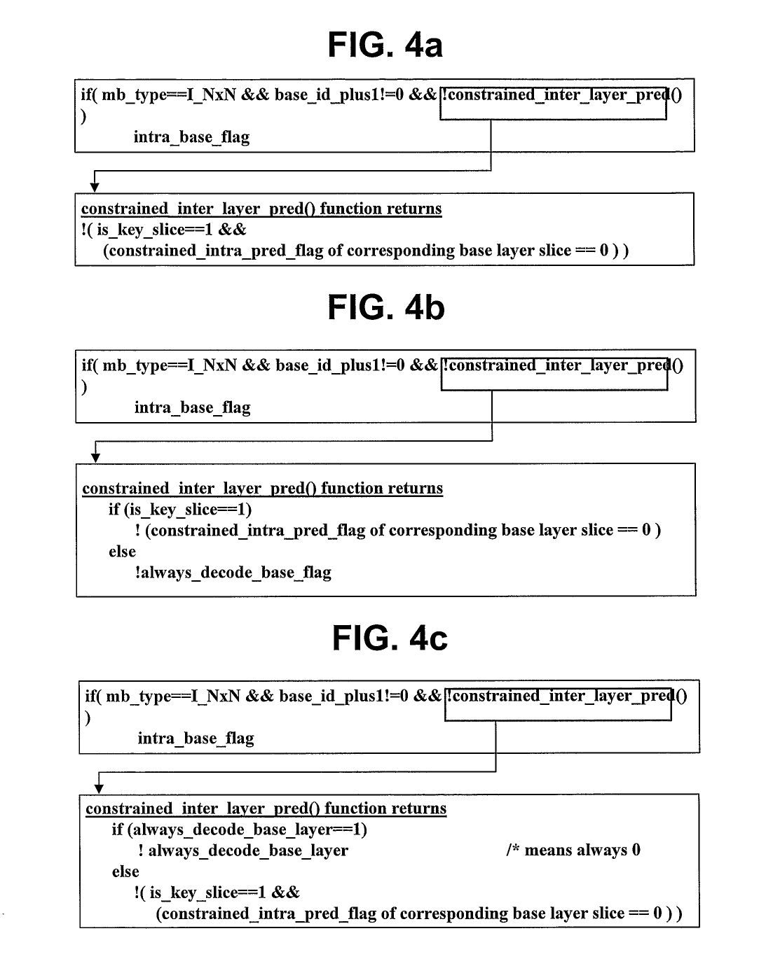

FIG. 4a illustrates a syntax of the operation for checking the flag “intra_base_flag” based on the procedure described above.

As illustrated in FIG. 4a, the EL decoder 230 checks a flag “intra_base_flag” of a current macroblock in a current picture when (a) the type of the current macroblock is intra-mode (i.e., mb_type==I_N×N); (b) inter-layer prediction has been performed for the current picture (i.e., base_id_plus1 !=0); and (c) inter-layer prediction is unconstrained (i.e., when constrained_inter_layer_pred( ) function returns FALSE(0)). The EL decoder 230 does not check the flag “intra_base_flag” unless all three conditions (a)-(c) are satisfied (for example, when there is a constraint on inter-layer prediction as described above).

The EL decoder 230 uses a predetermined function to determine whether inter-layer prediction is constrained or unconstrained. As illustrated in FIG. 4a, this determination function makes the determination (i.e., returns TRUE(1) OR FALSE(0)) based on whether or not a current picture including the current macroblock is a key picture and on a constrained_intra_pred_flag value of a corresponding block in the base layer.

The reason why whether or not the current picture is a key picture is used as a basis for the determination is that inter-layer prediction is constrained when the current picture is a non-key picture. Thus, when the current picture is a key picture, it is determined whether inter-layer prediction is constrained or unconstrained. The term “key picture” used in scalable coding refers to a picture which uses only a reconstructed quality base picture as a reference picture, and the term “non-key picture” refers to a picture which uses, as a reference picture, a picture reconstructed using an SNR enhancement layer picture and a quality base picture.

When the current picture is a key picture and the corresponding block in the base layer is set to an unconstrained intra prediction mode (i.e., constrained_intra_pred_flag==0), the determination function constrained_inter_layer_pred ( ) in FIG. 4a returns a value FALSE(0) indicating unconstrained inter-layer prediction, where the value of !constrained_inter_layer_pred( ) is TRUE. Specifically, it is determined that inter-layer prediction is unconstrained if the corresponding block in the base layer is set to an unconstrained intra prediction mode (i.e., constrained_intra_pred_flag==0) indicating that a residual of the corresponding block is to be reconstructed using reconstructed pixel values of an adjacent inter-mode block rather than a fixed value for the adjacent inter-mode block. The flag “constrained_intra_pred_flag” is present in information (for example, a Picture Parameter Set (PPS)) in a header of a picture (or slice) including the corresponding block in the base layer. The header is transferred from the BL decoder 240 to the EL decoder 230 so that the EL decoder 230 can determine the value of the flag “constrained_intra_pred_flag”.

Accordingly, if the picture including the current macroblock is not a key picture or if the corresponding block in the base layer is set to a constrained intra prediction mode (i.e., constrained_intra_pred_flag==1) indicating that a residual of the corresponding block is to be reconstructed using a fixed value for an adjacent inter-mode block, it is determined that inter-layer prediction is constrained since the value of !constrained_inter_layer_pred( ) is FALSE, so that the flag “intra_base_flag” is not checked as described above.

In other embodiments of the present invention, the EL decoder 230 uses a function for determining whether or not inter-layer prediction is constrained based on different conditions from those described above. FIGS. 4b and 4c illustrate these embodiments. Contrary to the embodiment of the FIG. 4a, the embodiments of FIGS. 4b and 4c are applied when inter-layer prediction is unconstrained even if the current picture is not a key picture.

The embodiment of FIG. 4b is identical to that of FIG. 4a when the current picture is a key picture. The embodiment of FIG. 4b differs from that of FIG. 4a in that, if a flag “always_decode_base_flag” is set when the current picture is not a key picture, the determination function returns FALSE, so that it is determined that inter-layer prediction is unconstrained, and the flag “intra_base_flag” is checked.

Even when the current picture is not a key picture, a base layer picture must be decoded before the current picture is decoded if the flag “always_decode_base_flag” is set. Accordingly, prediction of a current macroblock from a corresponding block in the base layer can be allowed even when the corresponding block has been coded in an inter mode. Accordingly, if the flag “always_decode_base_flag” is set under the condition that the current picture is not a key picture, it is determined that inter-layer prediction is unconstrained so that the flag “intra_base_flag” is checked, otherwise it is determined that inter-layer prediction is constrained so that the flag “intra_base_flag” is not checked.

The embodiment of FIG. 4c is identical to that of FIG. 4a when the flag “always_decode_base_flag” is 0. The embodiment of FIG. 4c differs from that of FIG. 4a in that, if the flag “always_decode_base_flag” is 1, it is determined that inter-layer prediction is unconstrained so that the flag “intra_base_flag” is checked.

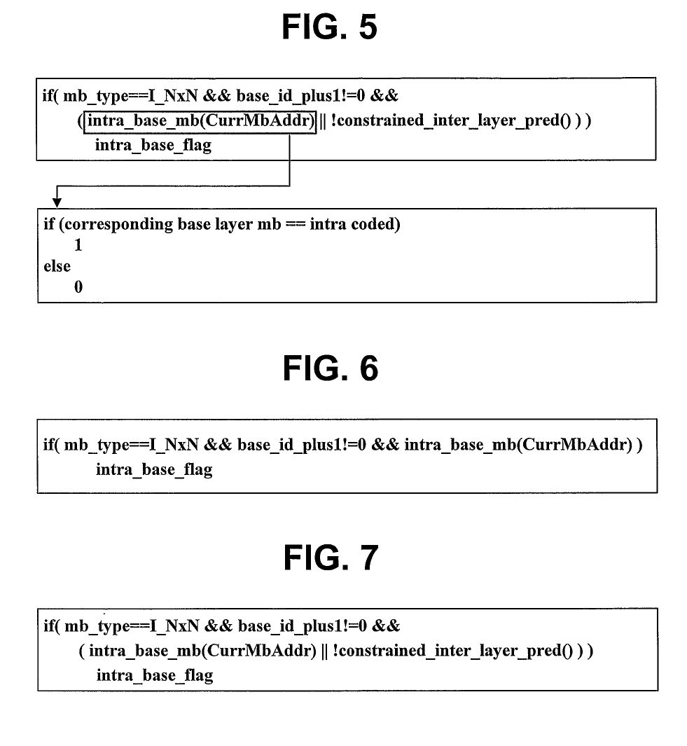

In the above embodiments, it is determined whether to check the flag “intra_base_flag” depending on the determination as to whether inter-layer prediction is constrained or unconstrained under the condition that “mb_type” is set and “base_id_plus1” is not 0. On the contrary, in another embodiment of the present invention, if the corresponding block in the base layer has been coded in an inter mode under the same condition, the flag “intra_base_flag” is checked or not depending on whether inter-layer prediction is constrained or unconstrained. If the corresponding block has been coded in an intra mode under the same condition, the flag “intra_base_flag” is checked regardless of the determination as to whether inter-layer prediction is constrained or unconstrained. Accordingly, the encoder transmits the flag “intra_base_flag” if the corresponding block in the base layer has been coded in an intra mode. FIG. 5 illustrates a syntax of the operation of the EL decoder 230 for checking the flag “intra_base_flag” according to this embodiment of the present invention.

In this embodiment, if the corresponding block in the base layer has been coded in an inter mode (i.e., intra_base_mb(CurrMbAddr) is FALSE(0)), the flag “intra_base_flag” is checked when inter-layer prediction is unconstrained. If the corresponding block in the base layer has been coded in an inter mode in the case of unconstrained inter-layer prediction (multi-loop coding), the encoder also transmits the flag “intra_base_flag” to indicate whether or not the current macroblock has been predicted from the corresponding block. The EL decoder 230 also checks the flag “intra_base_flag” under the same condition. If it is determined that inter-layer prediction is constrained and the current macroblock has been coded in an inter mode, the encoder does not transmit the flag “intra_base_flag” and the decoder also does not check the flag.

One of the functions suggested in the embodiments of FIGS. 4a-4c can be used as the function “constrained_inter_layer_pred( )” in the embodiment of FIG. 5.

In another embodiment of the present invention, the decoder determines whether to check the flag “intra_base_flag” (and the encoder determines whether to transmit the flag “intra_base_flag”) depending on whether or not the corresponding block has been coded in an intra mode, without determining whether inter-layer prediction is constrained or unconstrained. FIG. 6 illustrates a decoding syntax according to this embodiment. In this embodiment, if the corresponding block has been coded in an intra mode under the condition that the type of the current macroblock is intra-mode (i.e., mb_type==I_N×N) and inter-layer prediction has been performed on the picture including the current macroblock (i.e., base_id_plus1!=0), the flag “intra_base_flag” is checked, otherwise the flag “intra_base_flag” is not checked. Accordingly, if the corresponding block has been coded in an intra mode under the same condition, the encoder determines and transmits the value of the flag “intra_base_flag”, and if the corresponding block has been coded in an inter mode, the encoder does not transmit the flag “intra_base_flag”.

FIG. 7 illustrates a decoding syntax according to another embodiment of the present invention. In the embodiment of FIG. 7, only if it is determined that inter-layer prediction is unconstrained (i.e., constrained_inter_layer_pred( ) is FALSE) and the corresponding block has been coded in an inter mode (i.e., intra_base_mb(CurrMbAddr) is FALSE) under the condition that the type of the current macroblock is intra-mode (mb_type==I_N×N) and inter-layer prediction has been performed on the picture including the current macroblock (base_id_plus1!=0) does the decoder check the flag “intra_base_flag”. Otherwise, for example, if the corresponding block has been coded in an intra mode or if inter-layer prediction is constrained, the decoder does not check the flag “intra_base_flag” (and the encoder does not transmit the flag “intra_base_flag”). One of the functions suggested in the embodiments of FIGS. 4a-4c can also be used as the function “constrained_inter_layer_pred( )” in this embodiment.

According to the method described above, the decoder determines specific conditions in which it is unnecessary to check a flag indicating whether or not a target macroblock has been coded in an intra mode through prediction from a corresponding block of the base layer, and does not check the flag under the specific conditions, so that the encoder does not need to transmit the flag under the specific conditions.

When the decoder does not check the flag “intra_base_flag” under other specific conditions, not described above, according to the present invention, the encoder also does not transmit the flag “intra_base_flag” under the same conditions, thereby reducing the amount of coded data to be transmitted.

The decoder employing the decoding syntaxes described above can be incorporated into a mobile communication terminal, a media player, or the like.

As is apparent from the above description, a method for decoding a video signal according to the present invention determines conditions in which specific information is unnecessary, so that an encoder does not transmit the specific information in the conditions, thereby increasing the coding efficiency of the video signal.

Although this invention has been described with reference to the preferred embodiments, it will be apparent to those skilled in the art that various improvements, modifications, replacements, and additions can be made in the invention without departing from the scope and spirit of the invention. Thus, it is intended that the invention cover the improvements, modifications, replacements, and additions of the invention, provided they come within the scope of the appended claims and their equivalents.

1. A method for receiving and decoding an encoded bitstream of a first layer and an encoded bitstream of a second layer into a video signal, the method comprising the steps of:
a) determining whether or not inter-layer prediction is constrained when a target block in the first layer has been coded in an intra mode through prediction from a picture of the second layer; and
b) if it is determined that inter-layer prediction is constrained, skipping an operation for checking information indicating whether or not image data of the target block has been coded into difference data with reference to data, coded in an intra mode, of a block of the second layer corresponding to the target block.

2. The method according to claim 1, wherein, at the step a), it is determined that inter-layer prediction is unconstrained if the picture of the first layer is a key picture and it is indicated that a residual of the block of the second layer corresponding to the target block is to be reconstructed using reconstructed pixel values of an adjacent inter-mode block rather than using a fixed value for the adjacent inter-mode block.

3. The method according to claim 1, wherein, at the step a), when the picture of the first layer is a key picture, it is determined that inter-layer prediction is unconstrained if it is indicated that a residual of the block of the second layer corresponding to the target block is to be reconstructed using reconstructed pixel values of an adjacent inter-mode block rather than using a fixed value for the adjacent inter-mode block, whereas, when the picture of the first layer is not a key picture, it is determined that inter-layer prediction is unconstrained if it is indicated that the picture of the second layer is always to be decoded.

4. The method according to claim 1, wherein, at the step a), when it is indicated that the picture of the second layer is always to be decoded, it is determined that inter-layer prediction is unconstrained, whereas, when it is indicated that the picture of the second layer is not to be decoded always, it is determined that inter-layer prediction is unconstrained if the picture of the first layer is a key picture and it is indicated that a residual of the block of the second layer corresponding to the target block is to be reconstructed using reconstructed pixel values of an adjacent inter-mode block rather than using a fixed value for the adjacent inter-mode block.

5. The method according to claim 1, wherein, at the step a), it is further determined whether or not the block of the second layer corresponding to the target block is in an intra mode, and, at the step b), the operation for checking the information is skipped if it is determined that inter-layer prediction is constrained and the corresponding block of the second layer is not in an intra mode, otherwise the information is checked.

6. The method according to claim 1, wherein, at the step a), it is further determined whether or not the block of the second layer corresponding to the target block is in an intra mode, and, at the step b), the operation for checking the information is skipped if it is determined that the corresponding block of the second layer is in an intra mode or if it is determined that inter-layer prediction is constrained, otherwise the information is checked.

7. A method for receiving and decoding an encoded bitstream of a first layer and an encoded bitstream of a second layer into a video signal, the method comprising the steps of:
a) determining whether or not a block of the second layer corresponding to a target block in a picture of the first layer is in an intra mode under a condition that the picture of the first layer has been predicted from a picture of the second layer and the target block has been coded in an intra mode; and
b), if it is determined that the block of the second layer corresponding to the target block is not in an intra mode, skipping an operation for checking information indicating whether or not image data of the target block has been coded into difference data with reference to data, coded in an intra mode, of a corresponding block of a different layer.
